(19) United States
(12) Patent Application Publication
(10) Pub. No.: US 2026/0030740 A1
(43) Pub. Date: Jan. 29, 2026

(54) PROCESSING APPARATUS, MICROSCOPE, THREE-DIMENSIONAL IMAGE GENERATING METHOD, AND WORKPIECE PROCESSING METHOD

(71) Applicant: DISCO CORPORATION, Tokyo (JP)

(72) Inventor: Miu Tamamitsu, Tokyo (JP)

(21) Appl. No.: 19/242,107

(22) Filed: Jun. 18, 2025

(30) Foreign Application Priority Data
Jul. 23, 2024 (JP) 2024-117671

(51) Int. Cl. G06T 7/00; G02B 21/08; G06T 15/00

(52) U.S. Cl. CPC G06T 7/0008; G02B 21/08; G06T 15/00; G06T 2207/10056; G06T 2207/30164

(57) ABSTRACT

A processing apparatus includes: a holding unit configured to hold a workpiece; a processing unit configured to process the workpiece; and a microscope configured to observe the workpiece. The microscope includes: a light receiving element; a first lens configured to condense light from an inside of the workpiece; a second lens configured to condense the light condensed by the first lens to form an intermediate image; and an imaging optical system configured to form the light from the intermediate image on the light receiving element. The imaging optical system has an optical axis inclined with respect to an optical axis of the second lens and is configured to form, on the light receiving element, an inclined surface inclined in a direction not orthogonal to the optical axis of the second lens in the intermediate image.

### CROSS-REFERENCE TO RELATED APPLICATION(S)

The present application claims priority to and incorporates by reference the entire contents of Japanese Patent Application No. 2024-117671 filed in Japan on Jul. 23, 2024.

### BACKGROUND

The present disclosure relates to a processing apparatus, a microscope, a three-dimensional image generating method, and a workpiece processing method.

As a method of dividing a workpiece, such as a semiconductor wafer, there is a dividing method in which a modified layer is formed on the inside of the workpiece by positioning and irradiating a condensing point of a laser beam having a wavelength with a transparency to the workpiece on the inside of the workpiece to divide the workpiece using the formed modified layer as a starting point (see, for example, JP 3408805 B2).

In the method of JP 3408805 B2, it is known that the position, length, and the like of the formed modified layer correlate with the divisibility of the workpiece, and it is possible to determine whether the modified layer optimal for division has been formed by grasping information about the position, length, and the like of the modified layer.

Therefore, a processing apparatus capable of observing a modified layer formed inside a workpiece before division has been proposed (see, for example, JP 2019-140167 A).

The processing apparatus of JP 2019-140167 A performs an image acquisition step of intermittently moving an objective lens at a predetermined interval in a Z-axis direction orthogonal to an XY plane to acquire and record an XY plane image inside a wafer for each of a plurality of Z-axis coordinate values, and generates a three-dimensional image at a position imaged from the XY plane image recorded for each of the plurality of Z-axis coordinate values.

However, in order to generate a three-dimensional image of the inside of a workpiece at a certain region on the workpiece in the method of JP 2019-140167 A, it is necessary to repeat a step of generating a three-dimensional image by moving an objective lens in the Z-axis direction while the objective lens is arranged so as to be able to image a predetermined XY position, and an XY moving step of moving the objective lens so as to be able to image an XY position different from the already imaged position, and there is room for improvement in productivity.

### SUMMARY

A processing apparatus according to one aspect of the present disclosure includes: a holding unit configured to hold a workpiece; a processing unit configured to process the workpiece; and a microscope configured to observe the workpiece. The microscope includes: a light receiving element; a first lens configured to condense light from an inside of the workpiece; a second lens configured to condense the light condensed by the first lens to form an intermediate image; and an imaging optical system configured to form the light from the intermediate image on the light receiving element. The imaging optical system has an optical axis inclined with respect to an optical axis of the second lens and is configured to form, on the light receiving element, an inclined surface inclined in a direction not orthogonal to the optical axis of the second lens in the intermediate image.

A microscope according to another aspect of the present disclosure is configured to observe an object, and includes: a light receiving element; a first lens configured to receive light from the object; a second lens configured to condense the light having passed through the first lens to form an intermediate image having an optical magnification M, the second lens satisfying a relational expression: |M−n|≤n×0.1, where n denotes a refractive index of the object; an imaging optical system configured to form the light from the intermediate image on the light receiving element; and a diffraction grating disposed at a position of the intermediate image and configured to diffract the light from the second lens to guide the light to the imaging optical system. The imaging optical system has an optical axis inclined with respect to an optical axis of the second lens and is configured to form, on the light receiving element, an inclined surface inclined in a direction not orthogonal to the optical axis of the second lens in the intermediate image. The diffraction grating is disposed in such a manner that a normal line of the diffraction grating is parallel to the optical axis of the imaging optical system.

A three-dimensional image generating method according to still another aspect of the present disclosure is of generating a three-dimensional image of an inside of an object using the above-described microscope, and includes: relatively moving the microscope and the object along a moving direction intersecting an optical axis direction of the first lens; imaging, by the microscope, an inclined surface inclined in a direction not orthogonal to the optical axis direction inside the object via the inclined surface of the intermediate image; and generating a three-dimensional image of the inside of the object from a plurality of images acquired by repeating relatively moving of the microscope and the object and imaging of the inclined surface.

A workpiece processing method according to yet another aspect of the present disclosure is of processing a workpiece using the above-described processing apparatus that includes a laser oscillator configured to emit a laser beam having a wavelength with a transparency to the workpiece, and a condenser configured to condense the laser beam. The workpiece processing method includes: holding the workpiece by the holding unit; positioning a condensing point of the laser beam on the inside of the workpiece and irradiating the workpiece with the laser beam to form a modified layer on the inside of the workpiece; relatively moving the microscope and the workpiece formed with the modified layer along a moving direction intersecting an optical axis direction of the first lens; imaging, by the microscope, an inclined surface inclined in a direction not orthogonal to the optical axis direction inside the workpiece via the inclined surface of the intermediate image; and generating a three-dimensional image of a region including the modified layer on the inside of the workpiece from a plurality of images acquired by repeating relatively moving of the microscope and the workpiece and imaging of the inclined surface.

### BRIEF DESCRIPTION OF THE DRAWINGS

FIG. 1 is a perspective view illustrating a configuration example of a processing apparatus according to a first embodiment;

FIG. 2 is a view schematically illustrating a configuration of a microscope of the processing apparatus illustrated in FIG. 1;

FIG. 3 is a side view schematically illustrating a first lens of the microscope illustrated in FIG. 2 and an inclined surface inside a workpiece to be imaged;

FIG. 4 is a view schematically illustrating a second lens and a coupling optical system of the microscope illustrated in FIG. 2;

FIG. 5 is a flowchart illustrating a procedure of a workpiece processing method according to the first embodiment;

FIG. 6 is a view schematically illustrating a configuration of a microscope of a processing apparatus according to a second embodiment;

FIG. 7 is a side view schematically illustrating a first lens of the microscope illustrated in FIG. 6 and an inclined surface inside a workpiece to be imaged; and

FIG. 8 is a view schematically illustrating a second lens and a coupling optical system of the microscope illustrated in FIG. 6.

### DETAILED DESCRIPTION OF THE PREFERRED EMBODIMENTS

Embodiments for carrying out the present disclosure will be described in detail with reference to the drawings. The present invention is not limited by the description in the following embodiments. In addition, the constituent elements described below include those that can be easily conceived by those skilled in the art and those that are substantially the same. Furthermore, the configurations described below can be appropriately combined. In addition, various omissions, substitutions, or modifications in the configurations can be made without departing from the gist of the present invention.

### First Embodiment

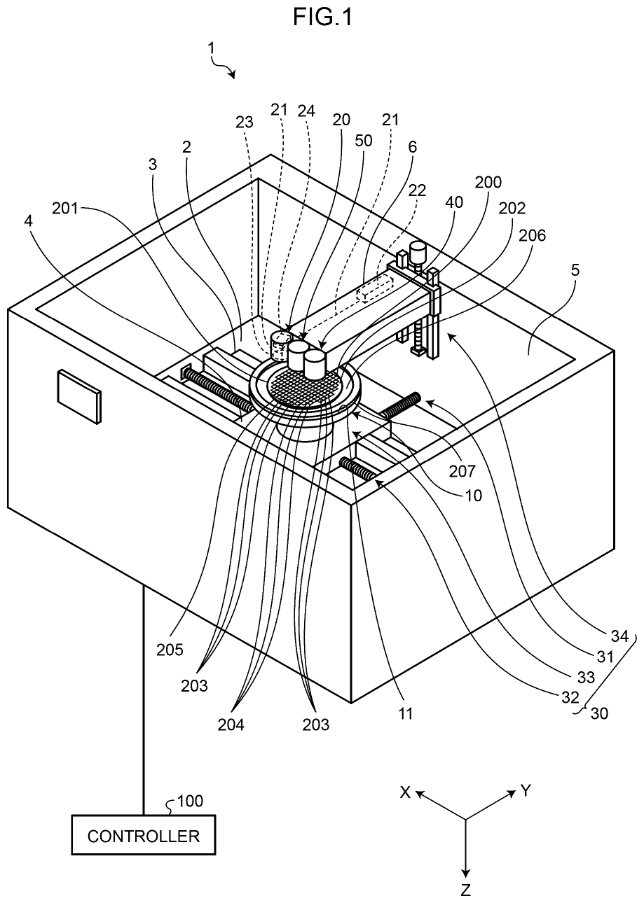

A processing apparatus according to a first embodiment of the present disclosure will be described with reference to the drawings. FIG. 1 is a perspective view illustrating a configuration example of the processing apparatus according to the first embodiment.

### Workpiece

A processing apparatus 1 illustrated in FIG. 1 according to the first embodiment is a processing apparatus that laser-processes a workpiece 200, which is an object. The workpiece 200 to be processed by the processing apparatus 1 according to the first embodiment is, for example, a wafer such as a disc-shaped semiconductor wafer or optical device wafer having a substrate 201 made of silicon, sapphire, gallium, SiC, or the like.

As illustrated in FIG. 1, the workpiece 200 is formed with a device 204 in each of regions divided into a lattice shape by a plurality of division lines 203 intersecting each other on a surface 202. The device 204 is, for example, an integrated circuit such as an integrated circuit (IC) or a large scale integration (LSI), an image sensor such as a charge coupled device (CCD) or a complementary metal oxide semiconductor (CMOS), a micro electro mechanical systems (MEMS), or a semiconductor memory (storage device).

In the first embodiment, the workpiece 200 is laser-processed by attaching a center of a disc-shaped tape 206 having a diameter larger than that of the workpiece 200 to a back surface 205 and attaching a ring-shaped frame 207 having an inner diameter larger than the outer diameter of the workpiece 200 to an outer edge of the tape 206.

### Processing Apparatus

Next, the processing apparatus 1 will be described. The processing apparatus 1 is a processing apparatus that irradiates the workpiece 200 with a laser beam 21 to form a modified layer along each division line 203 on the inside of the substrate 201 of the workpiece 200. As illustrated in FIG. 1, the processing apparatus 1 includes a holding unit 10, a moving unit 30, a laser beam irradiation unit 20, an imaging unit (not illustrated), a distance meter 40, a microscope 50, and a controller 100.

The holding unit 10 is disc-shaped and has a holding surface 11 formed of porous ceramic or the like along the horizontal direction in which the workpiece 200 is held. In addition, the holding unit 10 is provided so as to be movable by the moving unit 30 over a processing region below the laser beam irradiation unit 20 and a loading/unloading region separated from the lower side of the laser beam irradiation unit 20 in which the workpiece 200 is loaded and unloaded.

The holding unit 10 is connected to a vacuum suction source (not illustrated), and sucks and holds the workpiece 200 placed on the holding surface 11 by being sucked by the vacuum suction source. In the first embodiment, the holding unit 10 sucks and holds the back surface 205 side of the workpiece 200 via the tape 206 attached to the back surface 205 of the workpiece 200.

The moving unit 30 relatively moves the holding unit 10 and the laser beam irradiation unit 20. The moving unit 30 includes a Y-axis moving unit 31 that is an indexing unit that moves the holding unit 10 in a Y-axis direction parallel to the horizontal direction, an X-axis moving unit 32 that is a processing feeding unit that moves the holding unit 10 in an X-axis direction parallel to the horizontal direction and orthogonal to the Y-axis direction, a rotary moving unit 33 that rotates the holding unit 10 about an axis orthogonal to both the X-axis direction and the Y-axis direction and parallel to a Z-axis direction parallel to the vertical direction, and a Z-axis moving unit 34 that moves the laser beam irradiation unit 20 in the Z-axis direction.

The Y-axis moving unit 31 is installed in an apparatus body 2, and moves the holding unit 10 in the Y-axis direction by moving a moving plate 3 on which the X-axis moving unit 32 is installed in the Y-axis direction. The X-axis moving unit 32 is installed on the moving plate 3, and moves the holding unit 10 in the X-axis direction by moving a second moving plate 4 on which the rotary moving unit 33 is installed in the X-axis direction.

The rotary moving unit 33 is installed on the second moving plate 4, and rotates the holding unit 10 about the axis by supporting the holding unit 10. The Z-axis moving unit 34 is installed on a standing wall 5 that stands from the end of the apparatus body 2 in the Y-axis direction, and moves the laser beam irradiation unit 20, the distance meter 40, and the microscope 50 in the Z-axis direction by moving a support column 6 provided with the laser beam irradiation unit 20, the distance meter 40, and the microscope 50 at its tip in the Z-axis direction.

The Y-axis moving unit 31 moves the moving plate 3 to move the X-axis moving unit 32, the second moving plate 4, the rotary moving unit 33, and the holding unit 10 in the Y-axis direction. The X-axis moving unit 32 moves the second moving plate 4 to move the rotary moving unit 33 and the holding unit 10 in the X-axis direction.

Each of the Y-axis moving unit 31, the X-axis moving unit 32, and the Z-axis moving unit 34 includes a known ball screw provided so as to be rotatable about the axis, a known motor that rotates the ball screw about the axis, and a known guide rail that movably supports the moving plate 3, the moving plate 4, or the support column 6 in the Y-axis direction, the X-axis direction, or the Z-axis direction. The rotary moving unit 33 includes a known motor or the like that rotates the holding unit 10 about the axis.

The above-described Y-axis moving unit 31 and X-axis moving unit 32 are moving units that relatively move the microscope 50 and the holding unit 10 along the Y-axis direction or the X-axis direction that is a moving direction intersecting (orthogonal to, in the first embodiment) the optical axis direction of a first lens 61, which will be described later, of the microscope 50.

As illustrated in FIG. 1, the laser beam irradiation unit 20 is partially provided at the tip of the support column 6. The laser beam irradiation unit 20 is a processing unit that irradiates the workpiece 200 held by the holding unit 10 with the laser beam 21 to perform laser processing.

In the first embodiment, the laser beam irradiation unit 20 includes a laser oscillator 22 that emits the laser beam 21 having a wavelength with a transparency to the workpiece 200, a condenser lens 23 (corresponding to a condenser) that condenses the laser beam 21 on the inside of the workpiece 200 held by the holding unit 10, and a reflecting mirror 24 that reflects the laser beam 21 emitted by the laser oscillator 22 toward the condenser lens 23.

In the first embodiment, the laser beam irradiation unit 20 sets the condensing point of the laser beam 21 with a transparency to the workpiece 200 on the inside of the substrate 201 and irradiates each division line 203 to form a modified layer on the inside of the workpiece 200. Note that the modified layer means a region in which density, refractive index, mechanical strength, and other physical characteristics are different from those of the surrounding region, and examples of the modified layer include a melting treatment region, a crack region, a dielectric breakdown region, a refractive index change region, and a region in which these regions are mixed. In addition, the modified layer has lower mechanical strength and the like than other regions of the workpiece 200.

The imaging unit includes an imaging element that images a region where the modified layer is to be formed on the workpiece 200 held by the holding unit 10 before laser processing. The imaging element is, for example, a charge-coupled device (CCD) imaging element or a complementary MOS (CMOS) imaging element. The imaging unit images the workpiece 200 held by the holding unit 10, acquires an image for performing alignment to position the workpiece 200 and the laser beam irradiation unit 20 or the like, and outputs the acquired image to the controller 100.

The distance meter 40 is provided at the tip of the support column 6, and is arranged at a position in line with the laser beam irradiation unit 20 in the X-axis direction in the first embodiment. The distance meter 40 measures a distance in the Z-axis direction from the holding surface 11 of the holding unit 10 or the workpiece 200 held by the holding unit 10, and outputs a measurement result to the controller 100.

### Microscope

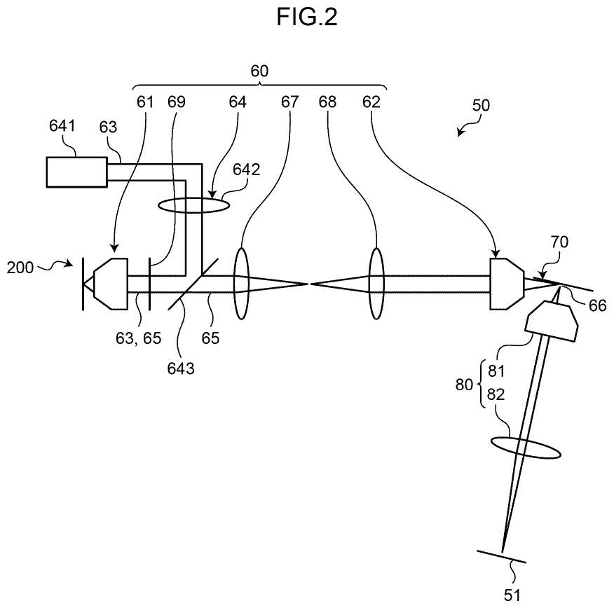

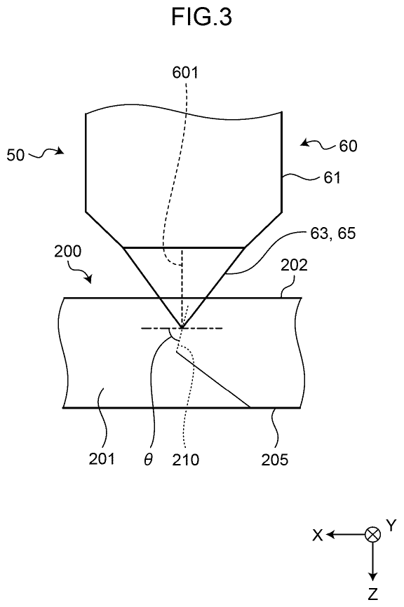

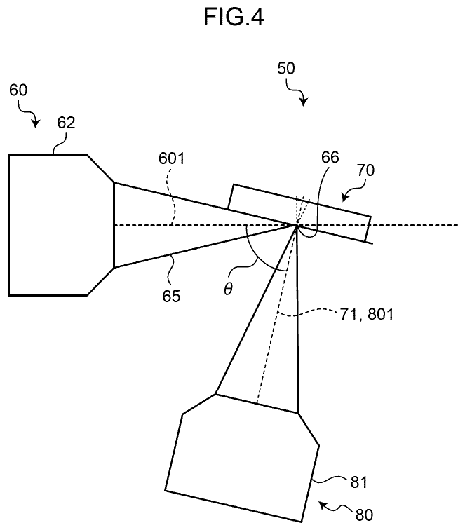

Next, the microscope 50 will be described. FIG. 2 is a view schematically illustrating a configuration of the microscope of the processing apparatus illustrated in FIG. 1. FIG. 3 is a side view schematically illustrating a first lens of the microscope illustrated in FIG. 2 and an inclined surface inside a workpiece to be imaged. FIG. 4 is a view schematically illustrating a second lens and a coupling optical system of the microscope illustrated in FIG. 2.

The microscope 50 illustrated in FIG. 2 observes the inside of the workpiece 200 held on the holding surface 11 of the holding unit 10. In the first embodiment, the microscope 50 is an oblique plane microscopy (OPM) that images an inclined surface 210 (illustrated in FIG. 3) inside the workpiece 200 held on the holding surface 11 of the holding unit 10. Note that the inclined surface 210 is a plane of part of the inside of the workpiece 200 positioned below the microscope 50 in the Z-axis direction, and whose angle θ with respect to the X-axis direction is constant in the Y-axis direction. Note that the angle θ exceeds 0 degrees and is less than 90 degrees.

As illustrated in FIG. 2, the microscope 50 includes a light receiving element 51, a relay optical system 60, a diffraction grating 70, and an imaging optical system 80. The light receiving element 51 includes an imaging element that captures an image formed by the imaging optical system 80. The light receiving element 51 includes, for example, a charge-coupled device (CCD) imaging element or a complementary MOS (CMOS) imaging element.

The relay optical system 60 includes a first lens 61 that faces the workpiece 200 held on the holding surface 11 of the holding unit 10 in the Z-axis direction, a light source unit 64 that irradiates the first lens 61 with illumination light 63, and a second lens 62 that condenses light 65 condensed by the first lens 61 to form an intermediate image 66.

The light source unit 64 includes a light source 641, a lens 642, and a polarizing beam splitter (PBS) 643. In the first embodiment, the light source 641 is a light-emitting diode (LED), and emits the illumination light 63 having a wavelength of 1200 nm. The lens 642 emits the illumination light 63 emitted by the light source 641 toward the PBS 643. The PBS 643 reflects the illumination light 63 toward the first lens 61.

The first lens 61 condenses the illumination light 63 from the PBS 643 on the inclined surface 210 inside the workpiece 200, condenses the light 65 from the inclined surface 210 inside the workpiece 200, and emits the light toward the PBS 643. The PBS 643 transmits the light 65 condensed by the first lens 61 toward the second lens 62. The second lens 62 condenses the light 65 condensed by the first lens 61 into space to form the intermediate image 66.

In addition, in the first embodiment, the relay optical system 60 is provided with a pair of lenses 67 and 68 between the PBS 643 and the second lens 62, and the pair of lenses 67 and 68 transmits the light 65 condensed by the first lens 61 to the second lens 62. In the first embodiment, the relay optical system 60 is further provided with a ¼ wave plate 69 between the first lens 61 and the PBS 643.

The diffraction grating 70 is arranged at a position of the intermediate image 66 on which the second lens 62 forms an image. In the first embodiment, the intermediate image 66 is formed on the surface by the second lens 62. The surface of the diffraction grating 70 is arranged so as to coincide with a surface conjugate with the inclined surface 210 inside the workpiece 200. In particular, when the optical magnification M=the refractive index n holds, the angle formed between a normal line (line segment orthogonal to the surface) 71 of the diffraction grating 70 and an optical axis 601 of the second lens 62 of the relay optical system 60 (also referred to as an optical axis of the first lens 61 or an optical axis of the relay optical system 60) is arranged so as to be the above-described angle θ as illustrated in FIG. 4. The diffraction grating 70 diffracts the light 65 from the second lens 62, that is, the intermediate image 66, and guides the light to the imaging optical system 80.

The imaging optical system 80 forms the intermediate image 66 diffracted by the diffraction grating 70 on the light receiving element 51. The imaging optical system 80 includes a pair of lenses 81 and 82 that forms the intermediate image 66 on the light receiving element 51. In particular, when the optical magnification M=the refractive index n holds, of the pair of lenses 81 and 82 of the imaging optical system 80, the lens 81 closer to the diffraction grating 70 is arranged in such a manner that the angle formed between an optical axis 801 (also referred to as an optical axis of the imaging optical system) and the optical axis 601 of the second lens 62 of the relay optical system 60 is the above-described angle θ as illustrated in FIG. 4.

As described above, the normal line 71 of the diffraction grating 70 is arranged so as to coincide with the optical axis 801 of the imaging optical system 80 in the first embodiment, but the normal line is only required to be arranged so as to be parallel in the present disclosure. In particular, when the optical magnification M=the refractive index n holds, the lens 81 is arranged in such a manner that the angle formed between the optical axis 801 and the optical axis 601 of the second lens 62 is the above-described angle θ, whereby the optical axis 801 of the imaging optical system 80 is inclined with respect to the optical axis 601 of the second lens 62.

In particular, when the optical magnification M=the refractive index n holds, the lens 81 is arranged in such a manner that the angle formed between the optical axis 801 and the optical axis 601 of the second lens 62 is the above-described angle θ, whereby the imaging optical system 80 forms, on the light receiving element 51, an image of the inclined surface 210 inside the workpiece 200 inclined in the direction in which the angle formed with the optical axis 601 of the second lens 62 in the intermediate image 66 is the angle θ (that is, a direction not orthogonal to the optical axis 601 of the second lens 62).

In particular, when the optical magnification M=the refractive index n holds, the microscope 50 includes the above-described imaging optical system 80, thereby capturing an image of the inclined surface 210 inclined in the direction in which the angle formed with the optical axis 601 of the second lens 62 is the angle θ (that is, a direction not orthogonal to the optical axis 601 of the second lens 62) inside the workpiece 200 through the intermediate image 66 formed by the second lens 62. The microscope 50 captures a predetermined number (for example, 30) of images of the inclined surface 210 per second by the light receiving element 51.

In addition, in the first embodiment, the microscope 50 is configured in such a manner that the focal lengths F1, F4, F2, and F3 of the lenses 61, 62, 67, and 68 satisfy the following Expressions (1) and (2), where n is the refractive index of the workpiece 200, F1 is the focal length of the first lens 61, F2 is the focal length of the lens 67, F3 is the focal length of the lens 68, F4 is the focal length of the second lens 62, and M is the optical magnification of the intermediate image 66 with respect to the inclined surface 210.

$$M = \frac{{F}_{2}}{{F}_{1}} \times \frac{{F}_{4}}{{F}_{3}} \qquad ( 1 )$$

$$M = n \qquad ( 2 )$$

If the refractive index n of the workpiece 200, the focal length F1 of the first lens 61, the focal length F2 of the lens 67, and the focal length F3 of the lens 68 are determined, the focal length F4 of the second lens 62 satisfies the following Expression (3).

$${F}_{4} = n \times \frac{{F}_{1} \times {F}_{3}}{{F}_{2}} \qquad ( 3 )$$

In the first embodiment, the workpiece 200 is made of silicon, the thickness of the workpiece 200 is 720 μm, the refractive index n of the workpiece 200 is 3.52, the focal length F1 of the first lens 61 is 1.8 mm, the numerical aperture (NA) of the first lens 61 is 0.85, the focal length F2 of the lens 67 is 153.5 mm, the focal length F3 of the lens 68 is 218 mm, the focal length F4 of the second lens 62 is 9.0 mm, the numerical aperture of the second lens 62 is 0.45, and the optical magnification M is 3.52. In addition, in the first embodiment, the focal length of the lens 81 of the imaging optical system 80 is 28.6 mm, the numerical aperture of the lens 81 is 0.22, and the focal length of the lens 82 is 130 mm.

As described above, in the first embodiment, the refractive index n and the optical magnification M satisfy the following Expression (4).

$$\vert M - n \vert = 0 \qquad ( 4 )$$

However, in the present disclosure, the focal lengths F1, F4, F2, and F3 of the lenses 61, 62, 67, and 68 of the relay optical system 60 is only required to be configured in such a manner that the refractive index n and the optical magnification M satisfy the following Expression (5). This is because if the difference between the optical magnification M and the refractive index n exceeds 10% of the refractive index n, the optical aberrations increase even if an image of the inclined surface 210 is acquired, and the state of the modified layer cannot be grasped with high accuracy. In addition, in the present disclosure, the relay optical system 60 may not include the lenses 67 and 68, and may include a lens in addition to the lenses 67 and 68. In any case, the relay optical system 60 is only required to be configured in such a manner that the focal lengths of the component lenses satisfy Expression (5).

$$\vert M - n \vert = n \times 0.1 \qquad ( 5 )$$

The controller 100 controls each constituent element of the processing apparatus 1 to cause the processing apparatus 1 to perform a processing operation on the workpiece 200. Note that the controller 100 is a computer including an arithmetic processing device including a microprocessor such as a central processing unit (CPU), a storage device including a memory such as a read only memory (ROM) or a random access memory (RAM), and an input/output interface device. The arithmetic processing device of the controller 100 performs arithmetic processing according to a computer program stored in the storage device, and outputs control signals for controlling the processing apparatus 1 to each constituent element of the processing apparatus 1 through the input/output interface device.

The controller 100 is connected to a display unit (not illustrated) constituted by a liquid crystal display device or the like that displays a state of a processing operation, an image, or the like, and an input unit (not illustrated) to be used by an operator to register processing detail information and the like. The input unit is constituted by at least one of a touch panel provided on the display unit and an external input device such as a keyboard.

### Processing Method

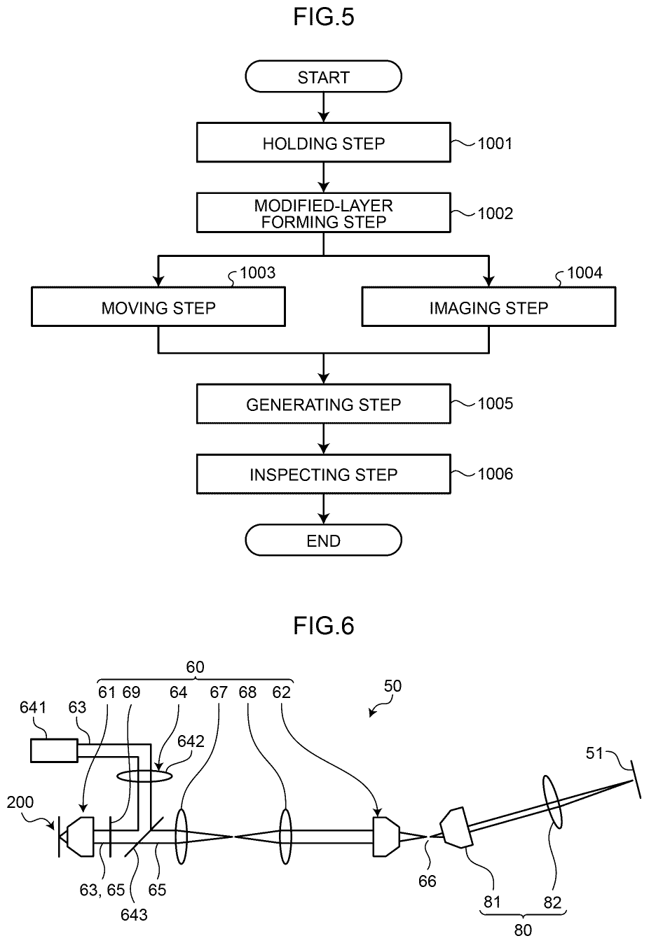

Next, a workpiece processing method according to the first embodiment will be described. FIG. 5 is a flowchart illustrating a procedure of the workpiece processing method according to the first embodiment. The workpiece processing method according to the first embodiment is a method of laser processing the workpiece 200 using the processing apparatus 1 having the above-described configuration. That is, the workpiece processing method is a method in which the processing apparatus 1 having the above-described configuration forms a modified layer along each division line 203 on the inside of the workpiece 200 and generates a three-dimensional image including the modified layer along each division line 203 on the inside of the workpiece 200.

As illustrated in FIG. 5, the workpiece processing method according to the first embodiment includes a holding step 1001, a modified-layer forming step 1002, a moving step 1003, an imaging step 1004, a generating step 1005, and an inspecting step 1006.

The holding step 1001 is a step of holding the workpiece 200 by the holding unit 10. In the first embodiment, in the holding step 1001, in the processing apparatus 1, processing conditions are registered in the controller 100 by an operator or the like, and the back surface 205 side of the workpiece 200 is placed on the holding surface 11 of the holding unit 10 via the tape 206. In the first embodiment, in the holding step 1001, in the processing apparatus 1, when the controller 100 receives a processing operation start instruction from the operator or the like, the controller 100 sucks and holds the back surface 205 side of the workpiece 200 on the holding surface 11 of the holding unit 10 via the tape 206.

The modified-layer forming step 1002 is a step of positioning the condensing point of the laser beam 21 on the inside of the workpiece 200 and irradiating the workpiece 200 with the laser beam 21 to form a modified layer on the inside of the workpiece 200. In the first embodiment, in the modified-layer forming step 1002, in the processing apparatus 1, the controller 100 controls the moving unit 30 to move the holding unit 10 toward the processing region, images the workpiece 200 by the imaging unit, and performs alignment based on the image captured by the imaging unit.

In the first embodiment, in the modified-layer forming step 1002, in the processing apparatus 1, the controller 100 controls the laser beam irradiation unit 20 and the moving unit 30 to relatively move the condenser lens 23 and the holding unit 10 of the laser beam irradiation unit 20 along each division line 203, positions the condensing point of the laser beam 21 on the inside of the workpiece 200, and irradiates the center of the division line 203 of the workpiece 200 with the laser beam 21 from the surface 202 side.

In the first embodiment, in the modified-layer forming step 1002, since the laser beam 21 has a wavelength with a transparency to the workpiece 200, the modified layer is formed along each division line 203 on the inside of the substrate 201. In the first embodiment, in the modified-layer forming step 1002, the processing apparatus 1 forms the modified layers on the inside of the workpiece 200 along all of the division lines 203. Note that, in the modified-layer forming step 1002, the processing apparatus 1 raises and lowers the laser beam irradiation unit 20 in the Z-axis direction by the Z-axis moving unit 34 based on the measurement result of the distance meter 40 in such a manner that the condensing point of the laser beam 21 is positioned at a predetermined position in the thickness direction of the substrate 201 of the workpiece 200 to keep the distance between the laser beam irradiation unit 20 and the workpiece 200 constant.

The moving step 1003 is a step of relatively moving the microscope 50 and the workpiece 200 along the X-axis direction intersecting the optical axis 601 direction of the first lens 61. In the first embodiment, in the moving step 1003, in the processing apparatus 1, the controller 100 controls the moving unit 30 to relatively move the workpiece 200 held by the holding unit 10 and the microscope 50 along each division line 203. In the first embodiment, in the moving step 1003, the processing apparatus 1 relatively moves the workpiece 200 and the microscope 50 along all of the division lines 203.

The imaging step 1004 is a step of imaging, by the microscope 50, the inclined surface 210 inclined at the angle θ with respect to the X-axis direction inside the workpiece 200 via the conjugate plane of the inclined surface 210 of the intermediate image 66, that is, the inclined surface 210 inclined in a direction not orthogonal to the optical axis 601 direction. In the first embodiment, in the processing apparatus 1, during the moving step 1003, the controller 100 controls the microscope 50 to capture a predetermined number of images of the modified layer on the inside of the workpiece 200 by the microscope 50 per second.

In the first embodiment, in the imaging step 1004, the processing apparatus 1 images the modified layers formed on the inside of the workpiece 200 along all of the division lines 203 by the microscope 50. Note that, in the moving step 1003 and the imaging step 1004, the processing apparatus 1 raises and lowers the microscope 50 in the Z-axis direction by the Z-axis moving unit 34 based on the measurement result of the distance meter 40 in such a manner that the inclined surface 210 described above includes the modified layer formed along each division line 203 on the inside of the substrate 201 of the workpiece 200 to keep the distance between the microscope 50 and the workpiece 200 constant. As described above, the distance meter 40 and the Z-axis moving unit 34 are height correction units that keep the distance between the first lens 61 of the microscope 50 and the holding surface 11 of the holding unit 10 or the workpiece 200 constant.

The generating step 1005 is a step of generating a three-dimensional image of a region including the modified layer on the inside of the workpiece 200 from a plurality of images including the modified layer on the inside of the workpiece 200 acquired by repeating the moving step 1003 and the imaging step 1004. In the first embodiment, in the generating step 1005, in the processing apparatus 1, the controller 100 combines the images captured by the microscope 50 in the imaging step 1004 to generate a three-dimensional image of the region including the modified layer on the inside of the workpiece 200. In this manner, the controller 100 relatively moves the microscope 50 and the holding unit 10 to image the inclined surface 210a plurality of times, and generates a three-dimensional image of the inside of the workpiece 200 from a plurality of acquired images.

Note that the moving step 1003, the imaging step 1004, and the generating step 1005 are a three-dimensional image generating method of generating a three-dimensional image including the modified layer on the inside of the workpiece 200 using the microscope 50 described above.

The inspecting step 1006 is a step of diagnosing the state of the modified layer based on the three-dimensional image generated in the generating step 1005. In the first embodiment, in the inspecting step 1006, in the processing apparatus 1, the controller 100 displays the three-dimensional image generated in the generating step 1005 on the display unit. In the first embodiment, in the inspecting step 1006, the operator determines the quality of the modified layer or the like based on the three-dimensional image displayed on the display unit. Note that the quality determination is performed based on, for example, the position where the modified layer has been formed on the inside of the workpiece 200 and whether the length of the modified layer is appropriate.

After the workpiece processing method according to the first embodiment is performed, the workpiece 200 is divided into individual devices 204 along the modified layers.

As described above, the processing apparatus 1 according to the first embodiment condenses the light 65 from the inclined surface 210 inside the workpiece 200 to form the intermediate image 66. In particular, when the optical magnification M=the refractive index n holds, the processing apparatus 1 images the inside of the workpiece 200 using the microscope 50, which is a so-called oblique plane microscopy and forms, on the light receiving element 51, an image of the inclined surface 210 inside the workpiece 200 inclined in the direction in which the angle formed with the optical axis 601 of the second lens 62 in the intermediate image 66 is the angle θ. For this reason, when acquiring the three-dimensional image of the inside of each division line 203, the processing apparatus 1 according to the first embodiment can image the inside of each division line 203 with a single continuous scan in the X-axis direction while keeping the distance between the microscope 50 and the workpiece 200 in the Z-axis direction constant, without repeating a step of capturing images a plurality of times by changing the position of the microscope 50 in the Z-axis direction by intermittently changing the XY position.

As a result, the processing apparatus 1 according to the first embodiment has an effect of improving productivity in generating a three-dimensional image of the inside of the workpiece 200.

Furthermore, in oblique plane microscopy, it is known in E. J. Botcherby et al., Optics Communications 281, 880 (2008) or https://amsikking.github.io/any immersion_remote refocus mi croscopy/that the intermediate image 66 can be generated with the influence of aberration suppressed by matching the refractive index n of an object to be imaged with the optical magnification M of the intermediate image 66 with respect to the inside of the object to be imaged.

Therefore, in the processing apparatus 1 according to the first embodiment, since the microscope 50 includes the imaging optical system 80 that satisfies the above-described Expression (4) or (5), it is possible to suppress the aberration of an image of the inside of the workpiece 200 captured by the microscope 50.

In addition, in the processing apparatus 1 according to the first embodiment, the second lens 62 of the microscope 50 forms the intermediate image 66 on the diffraction grating 70, and the imaging optical system 80 forms the intermediate image 66 formed on the diffraction grating 70 on the light receiving element 51. For this reason, the processing apparatus 1 according to the first embodiment can image, by the microscope 50, the inclined surface 210 inside the workpiece 200 in which the angle θ greater than, for example, 45 degrees. As a result, the processing apparatus 1 according to the first embodiment can image the inclined surface 210 including the modified layer on the inside of the workpiece 200 by the microscope 50.

### Second Embodiment

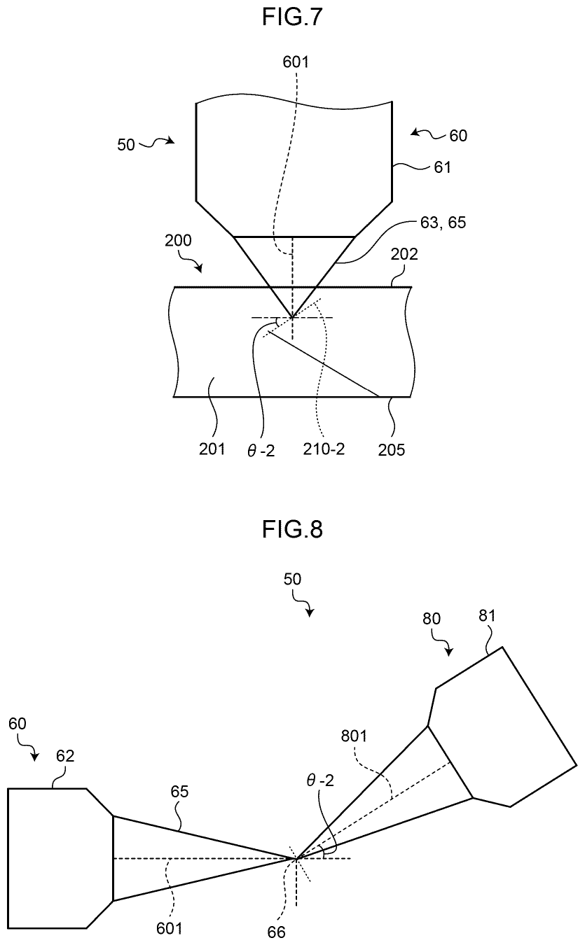

A processing apparatus according to a second embodiment will be described with reference to the drawings. FIG. 6 is a view schematically illustrating a configuration of a microscope of the processing apparatus according to the second embodiment. FIG. 7 is a side view schematically illustrating a first lens of the microscope illustrated in FIG. 6 and an inclined surface inside a workpiece to be imaged. FIG. 8 is a view schematically illustrating a second lens and a coupling optical system of the microscope illustrated in FIG. 6. In FIGS. 6, 7, and 8, the same elements as those of the first embodiment are denoted by the same reference signs, and the description thereof will be omitted.

As illustrated in FIG. 6, the processing apparatus 1 according to the second embodiment is equivalent in the configuration to the first embodiment except that the microscope 50 does not include the diffraction grating 70. In the processing apparatus 1 according to the second embodiment, since the microscope 50 does not include the diffraction grating 70, the microscope 50 images an inclined surface 210-2 inside the workpiece 200 having an angle θ-2 with respect to the X-axis direction smaller than the angle θ in the first embodiment, as illustrated in FIG. 7. For this reason, in the second embodiment, the angle θ-2 formed between the optical axis 601 of the relay optical system 60 and the optical axis 801 of the imaging optical system 80 is smaller than the angle θ of the first embodiment as illustrated in FIG. 8.

Similarly to the first embodiment, the processing apparatus 1 according to the second embodiment has an effect of improving productivity in generating a three-dimensional image of the inside of the workpiece 200 since the inside of the workpiece 200 is imaged using the microscope 50, which is a so-called oblique plane microscopy.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A processing apparatus comprising:
a holding unit configured to hold a workpiece;
a processing unit configured to process the workpiece; and
a microscope configured to observe the workpiece, wherein
the microscope includes:
a light receiving element;
a first lens configured to condense light from an inside of the workpiece;
a second lens configured to condense the light condensed by the first lens to form an intermediate image; and
an imaging optical system configured to form the light from the intermediate image on the light receiving element, and
the imaging optical system has an optical axis inclined with respect to an optical axis of the second lens and is configured to form, on the light receiving element, an inclined surface inclined in a direction not orthogonal to the optical axis of the second lens in the intermediate image.

2. The processing apparatus according to claim 1, further comprising:
a moving unit configured to relatively move the microscope and the holding unit along a moving direction intersecting an optical axis direction of the first lens; and
a controller configured to control the processing apparatus, wherein
the microscope is configured to image an inclined surface inclined in a direction not orthogonal to the optical axis direction inside the workpiece via the inclined surface of the intermediate image, and
the controller is configured to relatively move the microscope and the holding unit to image the inclined surface a plurality of times, and generate a three-dimensional image of the inside of the workpiece from a plurality of acquired images.

3. The processing apparatus according to claim 1, further comprising a diffraction grating disposed at a position of the intermediate image and configured to diffract the light from the second lens to guide the light to the imaging optical system.

4. The processing apparatus according to claim 1, wherein the processing apparatus satisfies a relational expression:
$$\vert M - n \vert \leq n \times 0.1 ,$$
where n denotes a refractive index of the workpiece; and
M denotes an optical magnification of the intermediate image.

5. The processing apparatus according to claim 4, further comprising a height correction unit configured to keep a distance between the first lens and a holding surface of the holding unit or the workpiece constant.

6. A microscope configured to observe an object, the microscope comprising:
a light receiving element;
a first lens configured to receive light from the object;
a second lens configured to condense the light having passed through the first lens to form an intermediate image having an optical magnification M, the second lens satisfying a relational expression:
$$\vert M - n \vert \leq n \times 0.1 ,$$
where n denotes a refractive index of the object;
an imaging optical system configured to form the light from the intermediate image on the light receiving element; and
a diffraction grating disposed at a position of the intermediate image and configured to diffract the light from the second lens to guide the light to the imaging optical system, wherein
the imaging optical system has an optical axis inclined with respect to an optical axis of the second lens and is configured to form, on the light receiving element, an inclined surface inclined in a direction not orthogonal to the optical axis of the second lens in the intermediate image, and
the diffraction grating is disposed in such a manner that a normal line of the diffraction grating is parallel to the optical axis of the imaging optical system.

7. A three-dimensional image generating method of generating a three-dimensional image of an inside of an object using the microscope according to claim 6, the three-dimensional image generating method comprising:
relatively moving the microscope and the object along a moving direction intersecting an optical axis direction of the first lens;
imaging, by the microscope, an inclined surface inclined in a direction not orthogonal to the optical axis direction inside the object via the inclined surface of the intermediate image; and
generating a three-dimensional image of the inside of the object from a plurality of images acquired by repeating relatively moving of the microscope and the object and imaging of the inclined surface.

8. A workpiece processing method of processing a workpiece using the processing apparatus according to claim 1,
the processing unit including a laser oscillator configured to emit a laser beam having a wavelength with a transparency to the workpiece, and a condenser configured to condense the laser beam, the workpiece processing method comprising:
holding the workpiece by the holding unit;
positioning a condensing point of the laser beam on the inside of the workpiece and irradiating the workpiece with the laser beam to form a modified layer on the inside of the workpiece;
relatively moving the microscope and the workpiece formed with the modified layer along a moving direction intersecting an optical axis direction of the first lens;
imaging, by the microscope, an inclined surface inclined in a direction not orthogonal to the optical axis direction inside the workpiece via the inclined surface of the intermediate image; and
generating a three-dimensional image of a region including the modified layer on the inside of the workpiece from a plurality of images acquired by repeating relatively moving of the microscope and the workpiece and imaging of the inclined surface.
